(19) United States
(12) Patent Application Publication
(10) Pub. No.: US 2008/0215974 A1
(43) Pub. Date: Sep. 4, 2008

(54) Interactive user controlled avatar animations

(76) Inventors: Phil Harrison, London (GB); Scott Waugaman, London (GB); Gary M. Zalewski, Oakland, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/789,202

(22) Filed: Apr. 23, 2007

Related U.S. Application Data
(60) Provisional application No. 60/892,397, filed on Mar. 1, 2007.

(51) Int. Cl. G06T 15/70

(52) U.S. Cl. 715/706; 715/711

(57) ABSTRACT

A method for controlling an avatar in a virtual space, the virtual space accessed through a computer network using a console, is disclosed. The method begins by capturing activity of a console controller and processing the captured activity of the console controller to identify input parameters. Another operation of the method is to map selected ones of the input parameters to portions of the avatar, the avatar being a virtual space representation of a user. Wherein the capturing, processing and mapping are continuously performed to define a correlation between activity of the console controller and the avatar that is the virtual space representation of the user.

### CLAIM OF PRIORITY

This Application claims priority to U.S. Provisional Patent Application No. 60/892,397, entitled “VIRTUAL WORLD COMMUNICATION SYSTEMS AND METHODS”, filed on Mar. 1, 2007, which is herein incorporated by reference.

### CROSS-REFERENCE TO RELATED APPLICATION

This application is related to: (1) U.S. patent application No. ______, (Attorney Docket No. SONYP067/SCEA06113US00) entitled “VIRTUAL WORLD AVATAR CONTROL, INTERACTIVITY AND COMMUNICATION INTERACTIVE MESSAGING”, filed on the same date as the instant application, (2) U.S. patent application No. ______, (Attorney Docket No. SONYP068/SCEA06114US00) entitled “VIRTUAL WORLD USER OPINION & RESPONSE MONITORING”, filed on the same date as the instant application, (3) U.S. patent application Ser. No. 11/403,179 entitled “SYSTEM AND METHOD FOR USING USER'S AUDIO ENVIRONMENT TO SELECT ADVERTISING”, filed on 12 Apr. 2006, and (4) U.S. patent application Ser. No. 11/407,299 entitled “USING VISUAL ENVIRONMENT TO SELECT ADS ON GAME PLATFORM”, filed on 17 Apr. 2006, (5) U.S. patent application Ser. No. 11/682,281 entitled “SYSTEM AND METHOD FOR COMMUNICATING WITH A VIRTUAL WORLD”, filed on 5 Mar. 2007, (6) U.S. patent application Ser. No. 11/682,284 entitled “SYSTEM AND METHOD FOR ROUTING COMMUNICATIONS AMONG REAL AND VIRTUAL COMMUNICATION DEVICES”, filed on 5 Mar. 2007, (7) U.S. patent application Ser. No. 11/682,287 entitled “SYSTEM AND METHOD FOR COMMUNICATING WITH AN AVATAR”, filed on 5 Mar. 2007, U.S. patent application Ser. No. 11/682,292 entitled “MAPPING USER EMOTIONAL STATE TO AVATAR IN A VIRTUAL WORLD”, filed on 5 Mar. 2007, U.S. patent application Ser. No. 11/682,298 entitled “Avatar Customization”, filed on 5 Mar. 2007, and (8) U.S. patent application Ser. No. 11/682,299 entitled “AVATAR EMAIL AND METHODS FOR COMMUNICATING BETWEEN REAL AND VIRTUAL WORLDS”, filed on 5 Mar. 2007, each of which is hereby incorporated by reference.

### BACKGROUND

1. Field of the Invention

The present invention relates generally to interactive multimedia entertainment and more particularly, interactive user control and manipulation representations of users in a virtual space.

2. Description of the Related Art

The video game industry has seen many changes over the years. As computing power has expanded, developers of video games have likewise created game software that takes advantage of these increases in computing power. To this end, video game developers have been coding games that incorporate sophisticated operations and mathematics to produce a very realistic game experience.

Example gaming platforms, may be the Sony Playstation or Sony Playstation2 (PS2), each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with other users over the Internet.

As game complexity continues to intrigue players, game and hardware manufacturers have continued to innovate to enable additional interactivity and computer programs. Some computer programs define virtual worlds. A virtual world is a simulated environment in which users may interact with each other via one or more computer processors. Users may appear on a video screen in the form of representations referred to as avatars. The degree of interaction between the avatars and the simulated environment is implemented by one or more computer applications that govern such interactions as simulated physics, exchange of information between users, and the like. The nature of interactions among users of the virtual world is often limited by the constraints of the system implementing the virtual world.

It is within this context that embodiments of the invention arise.

### SUMMARY

Embodiments defined herein enable computer controlled systems and programs to map interface input to particular aspects of a virtual world animated character, as represented on a screen. In one embodiment, specific buttons of a controller (e.g., game controller) are mapped to specific body parts of an avatar, that defines the virtual world animated character. In some embodiments, not only buttons map to avatar features, but also positioning, movement, triggers, placement and combinations thereof, so that a real-world user can accurately control the avatar, that is represented on the screen.

As will be noted below in more detail, the real-world user is able to control the avatar throughout a virtual world of places and spaces, and cause the interaction with other avatars (that may be controlled by other real-world users or computer controlled bots), or interface with things, objects, environments, and cause communication actions. The communication actions can be controlled by the controller, by way of the translation mapping that is transferred to the avatar in the form of visual, audio, or combinations thereof. Accordingly, the following embodiments shall be viewed broadly as examples of controls that are possible by mapping specific controller (e.g., game controller, or general computer controlling peripherals) buttons, movements (and combinations) to specific or selected body parts of an avatar, entire body movements of an avatar, body reactions of an avatar, facial reactions of avatar, emotions of an avatar, and the like.

In one embodiment, a method for controlling an avatar in a virtual space, the virtual space accessed through a computer network using a console, is disclosed. The method begins by capturing activity of a console controller and processing the captured activity of the console controller to identify input parameters. The next operation of the method is to map selected ones of the input parameters to portions of the avatar, the avatar being a virtual space representation of a user. Wherein the capturing, processing and mapping are continuously performed to define a correlation between activity of the console controller and the avatar that is the virtual space representation of the user.

In another embodiment, a method for interactively controlling an avatar through a computer network using a console is disclosed. The method begins by providing a console controller and determining a first position of the console controller. The method continues by capturing input to the console controller, the input including detecting movement of the console controller to a second position. Another step is processing input to the console controller and relative motion of the console controller between the first position and the second position. The next step of the method is mapping the relative motion between the first position and the second position of the console controller to animated body portions of the avatar. Wherein the capturing, processing and mapping are continuously performed to define a correlation between relative motion of the console controller and the avatar.

In yet another embodiment, a computer implemented method for interactively controlling an avatar within a virtual environment is disclosed. In this embodiment, a computer program that is executed on at least one computer in a computer network generates the avatar and virtual environment. The method begins by providing a controller interfaced with the computer program and mapping controller input to allow a user to control a select portion of the avatar. The method continues by capturing controller input and controller movement between a first position and a second position. The next step of the method is processing the captured controller input and controller movement and applying the captured movement to interactively animate the select portion of the avatar within the virtual environment. Wherein the capturing and processing of controller input and controller movement is continuously performed to define a correlation between controller movement and avatar animation.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1A is a schematic illustrating an avatar control system 100 in accordance with one embodiment of the present invention.

FIG. 1B illustrates various methods of transmitting motion and position detection between the controller 108 and console 110, in accordance with one embodiment of the present invention.

FIG. 2 shows an illustration of a user 102a interacting with an avatar controlling system in accordance with one embodiment of the present invention.

FIG. 3 shows an illustration of a user 102a interacting with an avatar controlling system in accordance with one embodiment of the present invention. FIG. 5 is

FIGS. 4A is an exemplary illustration of motion capture of relative controller movements effectuating changes in an avatar, in accordance with one embodiment of the present invention.

FIG. 4B is a flow chart illustrating how button selection on the controller can be used to define and supplement an avatar controlling system in accordance with one embodiment of the present invention.

FIG. 5A is an exemplary illustration of multiple motion captures of relative controller movements effectuating changes in an avatar, in accordance with one embodiment of the present invention.

FIG. 5B is another exemplary illustration of multiple motion captures of relative controller movements effectuating changes in an avatar, in accordance with one embodiment of the present invention.

FIG. 6 illustrates mapping controller buttons to control particular body parts of an avatar, in accordance with one embodiment of the present invention.

FIG. 7 illustrates controlling various aspects of an avatar during the display of an avatar animation, in accordance with one embodiment of the present invention.

FIG. 8 illustrates controlling various motions of an avatar's head in accordance with one embodiment of the present invention.

FIG. 9 schematically illustrates the overall system architecture of the Sony® Playstation 3® entertainment device, a console having controllers for implementing an avatar control system in accordance with one embodiment of the present invention.

FIG. 10 is a schematic of the Cell processor 928 in accordance with one embodiment of the present invention.

### DETAILED DESCRIPTION

An invention is disclosed for allowing real world users to control motions and actions of avatars within a virtual world. According to an embodiment of the present invention users may interact with a virtual world. As used herein the term virtual world means a representation of a real or fictitious environment having rules of interaction simulated by means of one or more processors that a real user may perceive via one or more display devices and/or may interact with via one or more user interfaces. As used herein, the term user interface refers to a real device by which a user may send inputs to or receive outputs from the virtual world. The virtual world may be simulated by one or more processor modules. Multiple processor modules may be linked together via a network. The user may interact with the virtual world via a user interface device that can communicate with the processor modules and other user interface devices via a network. Certain aspects of the virtual world may be presented to the user in graphical form on a graphical display such as a computer monitor, television monitor or similar display. Certain other aspects of the virtual world may be presented to the user in audible form on a speaker, which may be associated with the graphical display.

Within the virtual world, users may be represented by avatars. Each avatar within the virtual world may be uniquely associated with a different user. The name or pseudonym of a user may be displayed next to the avatar so that users may readily identify each other. A particular user's interactions with the virtual world may be represented by one or more corresponding actions of the avatar. Different users may interact with each other via their avatars. An avatar representing a user could have an appearance similar to that of a person, an animal or an object. An avatar in the form of a person may have the same gender as the user or a different gender.. The avatar may be shown on the display so that the user can see the avatar along with other objects in the virtual world.

Alternatively, the display may show the world from the point of view of the avatar without showing itself. The user's (or avatar's) perspective on the virtual world may be thought of as being the view of a virtual camera. As used herein, a virtual camera refers to a point of view within the virtual world that may be used for rendering two-dimensional images of a 3D scene within the virtual world. Users may interact with each other through their avatars by means of the chat channels associated with each lobby. Users may enter text for chat with other users via their user interface. The text may then appear over or next to the user's avatar, e.g., in the form of comic-book style dialogue bubbles, sometimes referred to as chat bubbles. Such chat may be facilitated by the use of a canned phrase chat system sometimes referred to as quick chat. With quick chat, a user may select one or more chat phrases from a menu. For further examples, reference may also be made to: (1) United Kingdom patent application no. 0703974.6 entitled “ENTERTAINMENT DEVICE”, filed on Mar. 1, 2007; (2) United Kingdom patent application no. 0704225.2 entitled “ENTERTAINMENT DEVICE AND METHOD”, filed on Mar. 5, 2007; (3) United Kingdom patent application no. 0704235.1 entitled “ENTERTAINMENT DEVICE AND METHOD”, filed on Mar. 5, 2007; (4) United Kingdom patent application no. 0704227.8 entitled “ENTERTAINMENT DEVICE AND METHOD”, filed on Mar. 5, 2007; and (5) United Kingdom patent application no. 0704246.8 entitled “ENTERTAINMENT DEVICE AND METHOD”, filed on Mar. 5, 2007, each of which is herein incorporated by reference.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

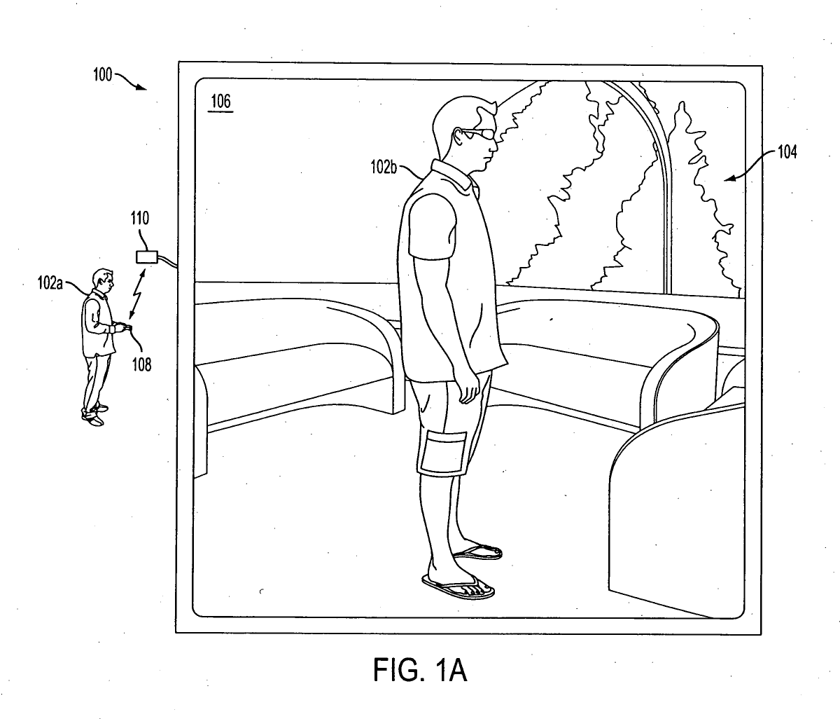

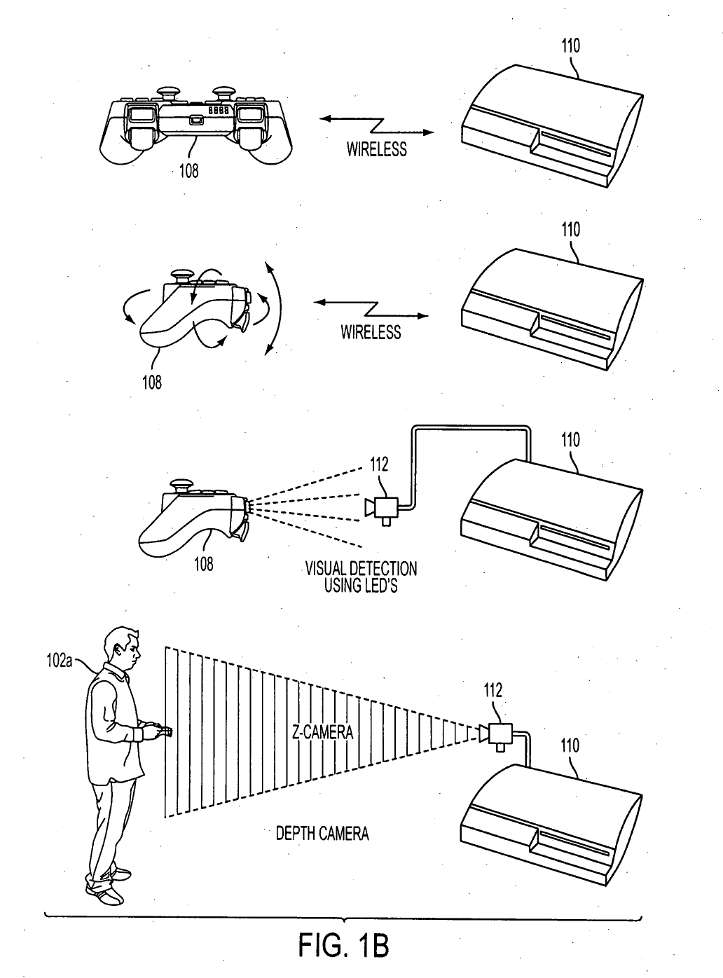

FIG. 1A is a schematic illustrating an avatar control system 100 in accordance with one embodiment of the present invention. A user 102a manipulates a controller 108 that can communicate with a console 110. In some embodiments, the console 110 can include a storage medium capable of saving and retrieving data. Exemplary types of storage mediums include, but are not limited to magnetic storage, optical storage, flash memory, random access memory and read only memory.

The console 110 can also include a network interface such as Ethernet ports and wireless network capabilities including the multitude of wireless networking standards found under IEEE 802.11. The network interface of the console 110 can enable the user 102a to connect to remote servers capable of providing real-time interactive game play with other console 110 users, software updates, media services, and access to social networking services.

The console 110 can also include a central processing unit and graphics processing units. The central processing unit can be used to process instructions retrieved from the storage medium while the graphics processing unit can process and render graphics to be displayed on a screen 106.

With the console 110 connected to the screen 106, the console 106 can display a virtual space 104 that includes an avatar 102b. In one embodiment, the virtual space 104 can be maintained on remote servers accessed using the network interface of the console 110. In other embodiments, portions of the virtual space 104 can be stored on the console 110 while other portions are stored on remote servers. In some embodiments, the virtual space 104 is a virtual three-dimensional world displayed on the screen 106. The virtual space 104 can be a virtual representation of the real world that includes geography, weather, flora, fauna, currency, and politics. Similar to the real world, the virtual space 104 can include urban, suburban, and rural areas. However, unlike the real world, the virtual space 104 can have variable laws of physics. The previously discussed aspects of the virtual space 104 are intended to be exemplary and not intended to be limiting or restrictive. As a virtual space, the scope of what can be simulated and modeled can encompass anything within the real world and is only limited by the scope of human imagination.

A user can interact with the virtual space 114 using their avatar 102b. The avatar 102b can be rendered three-dimensionally and configured by the user 102a to be a realistic or fanciful representation of the user 102a in the virtual space 104. The user 102a can have complete control over multiple aspects of the avatar including, but not limited to, hair style, head shape, eye shape, eye color, nose shape, nose size, ear size, lip shape, lip color, clothing, footwear and accessories. In other embodiments, the user 102a can input a photograph of their actual face that is can be mapped onto a three-dimensional wire-frame head and body.

FIG. 1B illustrates various methods of transmitting motion and position detection between the controller 108 and console 110, in accordance with one embodiment of the present invention. The user 102a can control the avatar 102b within the virtual space 104 using the controller 108. In one embodiment, the controller 108 can transmit signals wirelessly to the console 110. As multiple controllers can be in use with a single console 110, interference between individual controllers can be accomplished by transmitting wireless signals at particular frequencies or use radio and communications protocols such as Bluetooth. The controller 108 can include multiple buttons and joysticks that can be manipulated by the user to achieve a variety of effects such as navigating and selecting items from an on screen menu. Similarly, the buttons and joysticks of the controller 108 can be mapped to control aspects of computer programs executed by the console 110.

The controller 108 can also include motion sensors capable of detecting translation and rotation in the x-axis, y-axis, and z-axis. In one embodiment, the motion sensors are inertial sensors capable of detecting motion, acceleration and deceleration of the controller 108. In other embodiments, the motion of the controller 108 can be detected in all axes using gyroscopes. The controller 108 can wirelessly transmit data from the motions sensors to the console 110 for processing resulting in actions displayed on a screen.

A camera 112 can also be connected to the console 110 to assist in providing visual detection of the controller 108. In one embodiment, the camera 112 and LEDs positioned on the controller 108 provide visual detection of the controller 108 to the console 110. The LEDs, capable of emitting light within the visible spectrum or outside the visible spectrum, can be integrated into the controller in an array that assists in determining if the controller is off axis to the camera 112. In other embodiments, the LEDs can be modularly attached to the controller 108.

The camera 112 can be configured to receive the light emitted from the LEDs while the console 110 can calculate movement of the controller 108 based on changes of the LEDs relative to the camera 112. Furthermore, in embodiments where multiple controllers are associated with a single console 110, the LEDs of different controllers can be differentiated from each other using individual blink patterns or frequencies of light.

In other embodiments, the camera 112 is a depth camera that can help determine a distance between the camera 112 and the controller 108. In some embodiments, the depth camera can have a maximum scan depth. In this situation, depth values are only calculated for objects within the maximum scan depth. As shown in FIG. 1B, the camera 112 has a maximum scan depth of Z. As the controller 108 is within the maximum scan depth, the distance between the camera 112 and the controller 108 can be calculated. In still other embodiments, combinations of inertial sensors, LED detection and depth cameras can be used to refine motion and position detection. In one embodiment, the camera 112 can be integrated into the console 110. In other embodiments, the camera 112 can be positioned independent of the console 110.

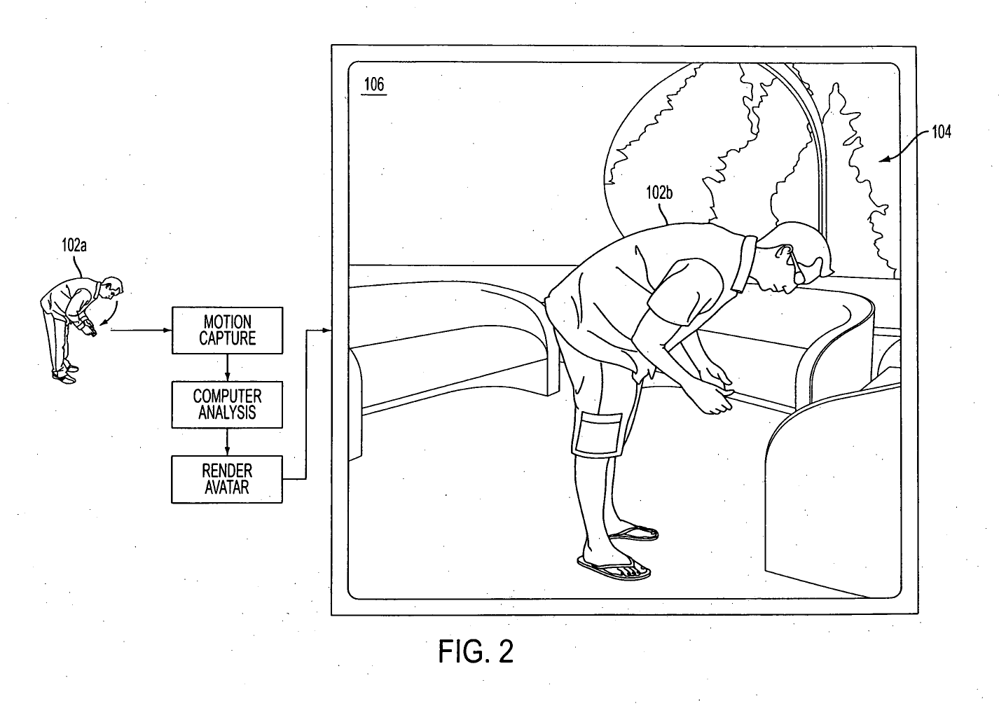

FIG. 2 shows an illustration of a user 102a interacting with an avatar controlling system in accordance with one embodiment of the present invention. User 102a, holding a controller 108, is shown bending over at the waist. As the user 102a bends at the waist, the controller 108 is pitched down from an initial substantially horizontal position to the position illustrated in FIG. 2. The pitching down of the controller 108 can be captured by the motion capture system in operation 120. In operation 122, computer analysis can be performed by the console to map the motion capture of the controller 108 to a particular body part of the avatar 102b. Operation 124 renders an animation of the avatar 102b that can be output from the console to the screen 106.

As shown in FIG. 2, the motion capture of the controller 108 can be mapped to the waist of the avatar 102b. In other embodiments, motion capture of controller 108 movements can be mapped to different body parts of the avatar 102b such as legs, arms, hands, and head. In yet other embodiments, motion capture from the controller 108 can be combined with other forms of user input to effectuate changes in the avatar 102b. For example, a microphone and camera system can be used to monitor when the user 102a speaks resulting in animation of the mouth of the avatar 102b. The user 102a can also use buttons on the controller 108 to change and customize reactions and movements of the avatar 102b.

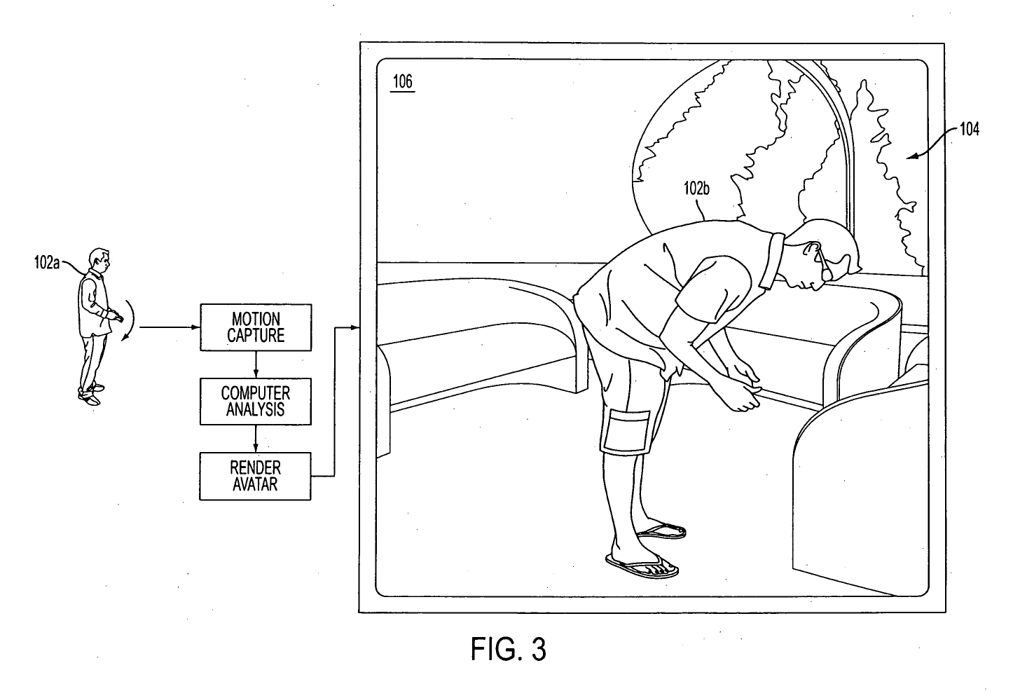

FIG. 3 shows an illustration of a user 102a interacting with an avatar controlling system in accordance with one embodiment of the present invention. In this embodiment, the user 102 is shown pitching the controller 108 down from an initial substantially horizontal position to the position seen in FIG. 3. Similar to FIG. 2, the downward pitch of the controller can be detected by the motion capture system in operation 120. Operation 122 can perform computer analysis of the motion capture and operation 124 can render the motion capture to the avatar 102b.

Comparing FIG. 2 and FIG. 3 illustrates that motion capture of relative controller movement can effectuate change in the avatar 102b. In FIG. 2, as the user 102 bends at the waist and the motion capture system can detect changes in the controller 108 position. In FIG. 3, a wrist movement from the user 102a can pitch the controller 108 down. While the user 102a performs different physical motions, the pitching down of the controller 108 is the relative motion captured and analyzed by the controller. Thus, when mapped to the same avatar body parts, different physical motions of the user 102a that result in similar relative motions of the controller 108, can result in similar animation for the avatar 102b.

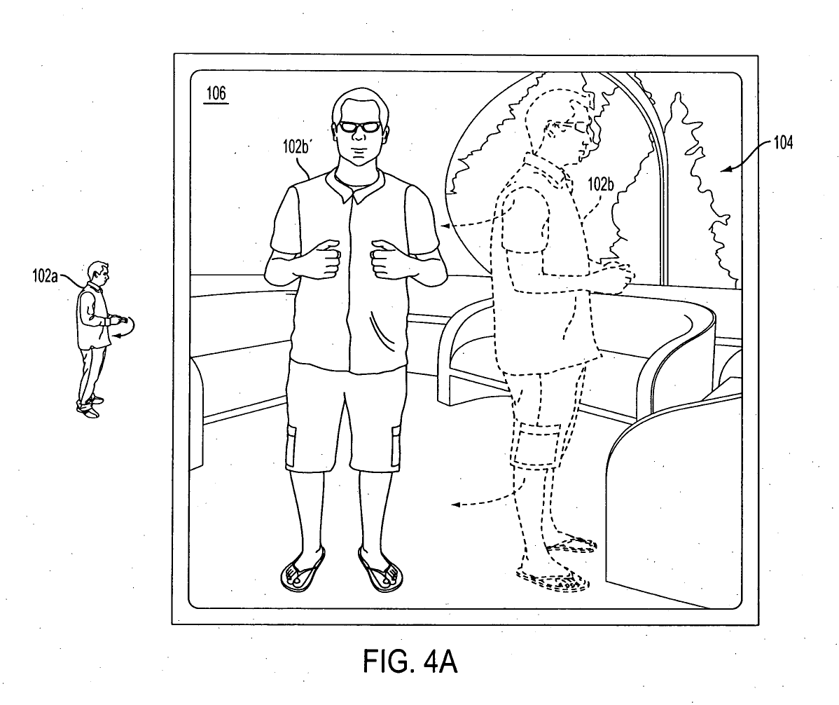

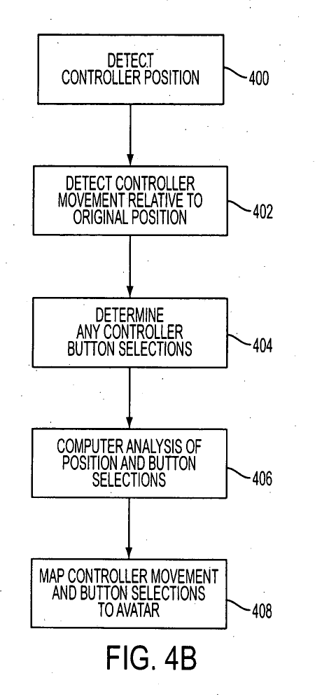

FIGS. 4A is an exemplary illustration of motion capture of relative controller movements effectuating changes in an avatar, in accordance with one embodiment of the present invention. In this embodiment, avatar 102b represents a before motion capture view and avatar 102b′ illustrates an after motion capture view. Initially, the user 102a, holding the controller 108, is represented by the avatar 102b. As the user 102a yaws the controller 108 ninety degrees to user's 102a right, motion capture of the relative motion of the controller 108 is analyzed and applied to the avatar 102b. In this embodiment, motion of the controller 108 is mapped to the entire body of the avatar 102b so the ninety degree yaw of the controller 108 results in avatar 102b′.

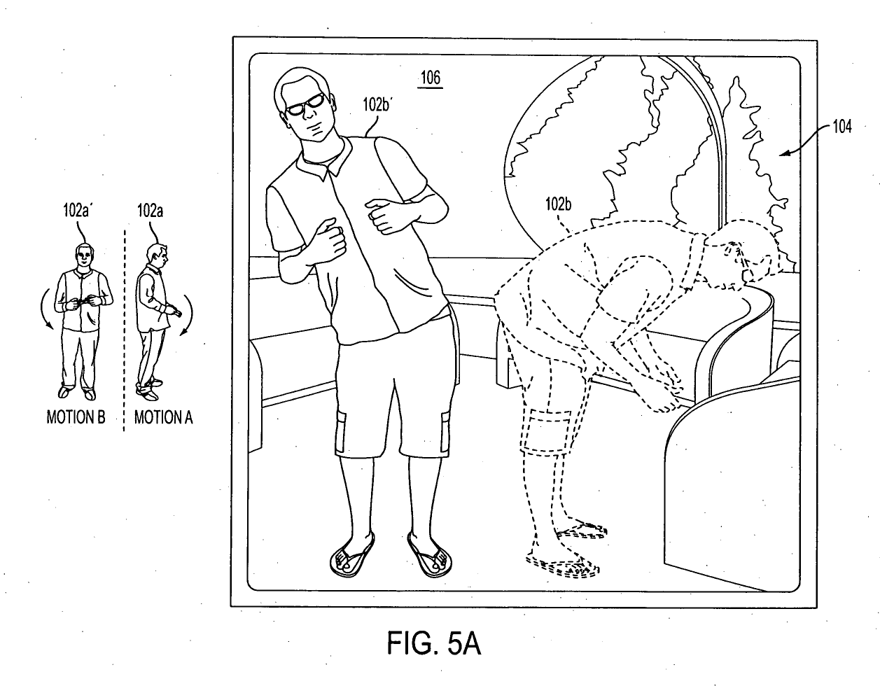

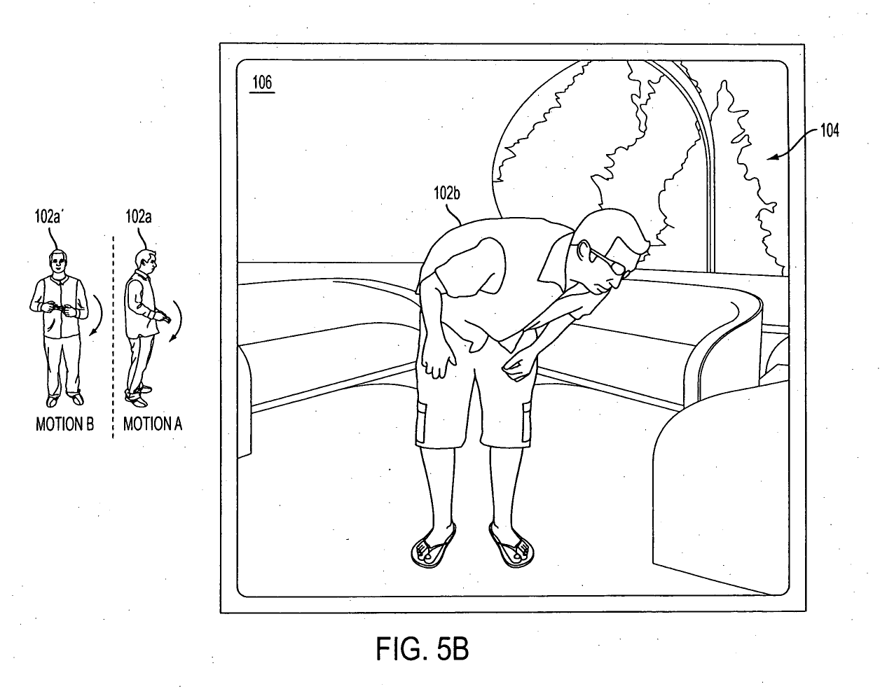

FIG. 4B is a flow chart illustrating how button selection on the controller can be used to define and supplement an avatar controlling system in accordance with one embodiment of the present invention. As previously discussed, different aspects of an avatar can be controlled by various relative motion of a controller. To enrich the interactivity and realism of an avatar, it can be beneficial to allow users to control facial expressions, hand gestures and other traits, expressions and emotions of their avatar. To accomplish this level of avatar control, supplemental input other than motion capture of relative motion of the controller may be used. Button on the controller can be mapped to select, control, and manipulate the possibly endless variations of avatar expressions and emotions. The flow chart in FIG. 5 illustrates how button selection on the controller can be used to define and supplement an avatar control system. In operation 500 a motion detection system detects a first controller position. This is followed by operation 502 that detects movements of the controller relative to the first controller position. In operation 504, it is determined if any buttons on the controller have been selected. Computer analysis of the controller button selections and of the relative movements of the controller is completed in operation 506. This is followed by operation 508 where the controller movements and button selections are mapped to the avatar.

FIG. 5A is an exemplary illustration of multiple motion captures of relative controller movements effectuating changes in an avatar, in accordance with one embodiment of the present invention. The user 102a performs motion A by imparting a downward pitch to the controller 108. The motion capture of motion A is mapped to the waist of the avatar 102b and results in avatar 102b bending over at the waist. Performing motion B, the user 102a yaws the controller to the user's right while pitching the controller up to a substantially horizontal position and rolling the controller to the user's right. In this embodiment, yawing the controller is mapped to the direction the avatar faces. Thus, the yaw to the user's right results in the avatar 102b rotating into the forward facing position seen in avatar 102b′. As previously discussed, in this embodiment pitching the controller 108 is mapped to movement of the waist of the avatar. Thus, when motion B is performed, pitching up of the controller 108 to a substantially horizontal position brings the avatar from the bent over position of avatar 102b to the straightened position of avatar 102b′. In this embodiment, rolling the controller 108 is mapped to leaning the avatar at the waist so that the roll of the controller to the user's right results in the avatar 102b′ leaning to the avatar's right.

FIG. 5B is another exemplary illustration of multiple motion captures of relative controller movements effectuating changes in an avatar, in accordance with one embodiment of the present invention. The user performs motion A by imparting a downward pitch to the controller 108. The motion capture of motion A is mapped to the waist of the avatar 102b and results in avatar 102b bending over at the waist. Without bringing the controller 108 back to a substantially horizontal position, the user 102a′ performs motion B. With motion B, the user 102a′ rolls the controller to the user's left. In this embodiment, rolling the controller leans the avatar 102b to the avatar's left. Thus, the combined Motion A and Motion B results in the avatar 102b being bent forward at the waist and leaning to the avatar's left. As the controller 108 includes sensors capable of measuring acceleration and deceleration, the animation of the avatars 102b can correlate to actual movement of the controller 108, by the user 102a/a′.

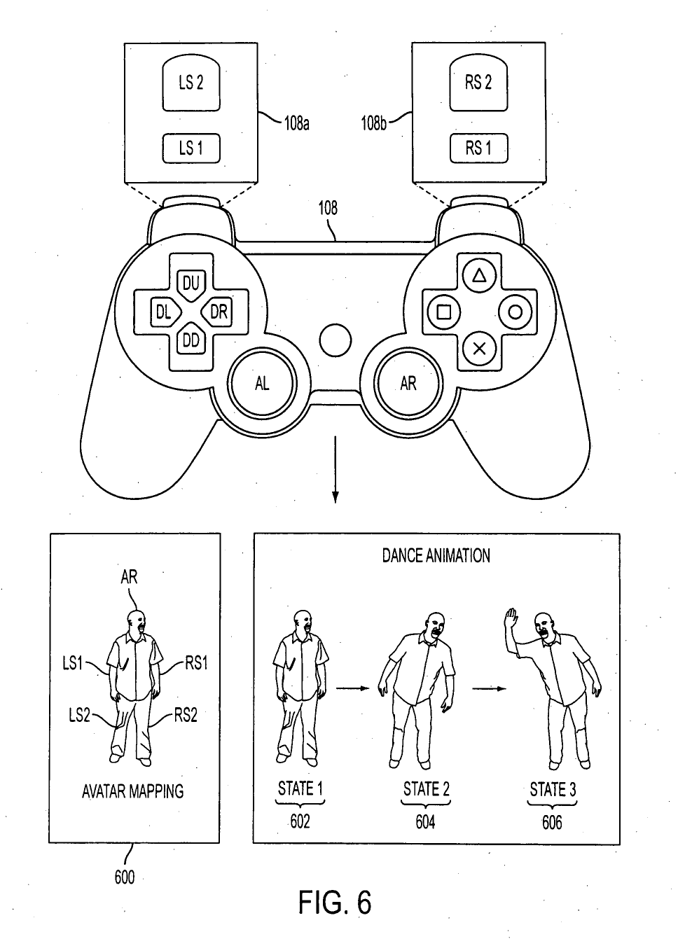

FIG. 6 illustrates mapping controller buttons to control particular body parts of an avatar, in accordance with one embodiment of the present invention. The controller 108 can have a variety of buttons including a digital control pad represented by DU, DR, DD and DL. The controller can also have left shoulder buttons 108a that include LS1 and LS2. Similarly, right shoulder buttons 108b include RS1 and RS2. Analog sticks AL and AR can be included on the controller 108 where the analog sticks are also capable of acting as buttons when depressed. The controller can also have selection buttons illustrated in FIG. 6 as a square, triangle, circle and “X”. While particular names and symbols have been used to describe the controller 108, the names are exemplary and not intended to be limiting.

In one embodiment, the various buttons of the controller 108 can be mapped to activate control of particular body parts of an avatar. As shown in avatar mapping 600, depressing AR can place a user in control of the avatar's head. Depressing RS1 or RS2 can allows a user to respectively control the right arm or right leg of the avatar. Similarly, LS1 and LS2 are respectively mapped to control the avatar's left arm and left leg. In addition to being able to control various parts of the avatar, a user can initiate and modify pre-rendered avatar animations. The user can initiate an avatar animation with a single or multiple button presses, single or multiple controller movements, or sequences of button presses in conjunction with controller movements.

As shown in dance animation 601, an avatar animation can be considered a sequence of various states. In one embodiments, state1 602, has the user's avatar is in a rest position or position prior to the initiation of the dance animation. State 2 604, can be considered the state of the avatar just after initiation of the dance animation. In this embodiment, the avatar has leaned to its left. In state 3 606, the final state of the dance animation 601, the user's avatar has leaned to it's right and raised it's right arm. As the dance animation 601 is intended to convey various states of an avatar, transition frames between the various states are not shown. It should be apparent to one skilled in the art that additional frames may be required to smoothly animate the avatar between the various states. Other embodiments of avatar animations can contain fewer or additional states, as the dance animation 601 is exemplary and not intended to be limiting.

As previously discussed, the controller 108 can detect acceleration and deceleration of translational and rotational motion in a three axes. This allows a user to interactively control directional movement of the animation and the rate animation of the avatar based on user input such as actual acceleration and deceleration of translational and rotational movement of the controller. Furthermore, the mapping of controller buttons to activate control of particular body parts of an avatar allows a user to decide which body part, or body parts, of the avatar to interactively animate. This can result in unique avatar animations because the user directly controls the animation of particular body parts of the avatar. Avatar animations that are responsive to direct control from the user are different from pre-mapped, pre-defined and pre-rendered avatar animations found in other forms of avatar animation.

For instance, although some system may allow control of an animated character in a game, in one embodiment, the disclosed mapping of controller movement, controller input, and controller positioning to particular parts of an avatar enable specific identification of avatar aspects to control, a degree of control and the resulting application of such control to the animated avatar. Still further, the avatar character is not tied to a particular pre-defined game, game scenes, or environments or game levels experiences. For instance, an avatar, as controlled by a real-world user, is able to define locations to visit, things to interact with, things to see, and experiences to enjoy. The experiences of the avatar in the virtual environment and the motions, reactions, and body movements are created on demand of the input defined by the real-world user, as dictated by controller activity.

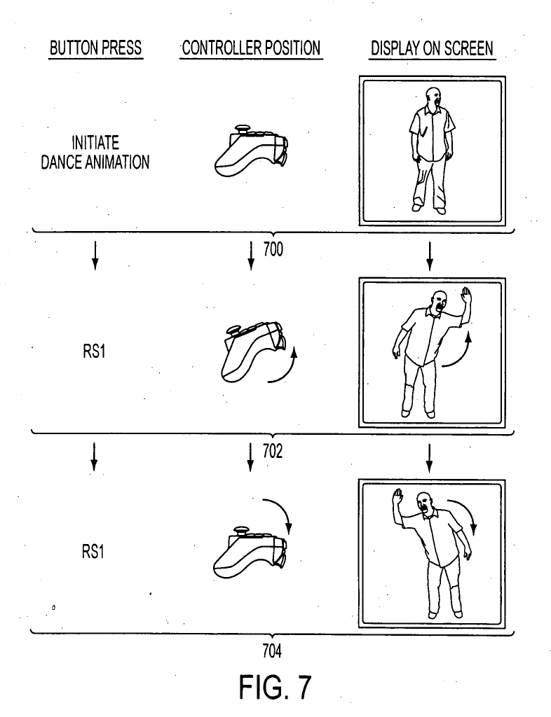

FIG. 7 illustrates controlling various aspects of an avatar during the display of an avatar animation, in accordance with one embodiment of the present invention. In state 700, a button press combination using the controller 108 can be used to initiate state 1 602 of an avatar dance animation on the screen 106. As shown in state 700, the controller 108 is in a position that is substantially horizontal. In state 702, the user depresses and holds LS1 to control the left arm of the avatar. Thus, when the user pitches the controller 108 up, the avatar's left arm is raised into the position seen in state 604a on the screen 106. Moving to state 704, the user continues to hold LS1 while pitching the controller 108 down to a substantially horizontal position. As the controller is pitched down, on the screen 106, the avatar's left arm is lowered into the position seen in state 606a.

In other embodiments, a user can depress and release a button corresponding to a selected portion of an avatar and continue to control that portion of an avatar until the button is pressed a second time. To assist a user in determining which portion of their avatar they are controlling, it is possible to highlight the controlled portion of the avatar on the screen 106. This highlighting can be displayed only to the user controlling the avatar and may not be visible to other users in the virtual space.

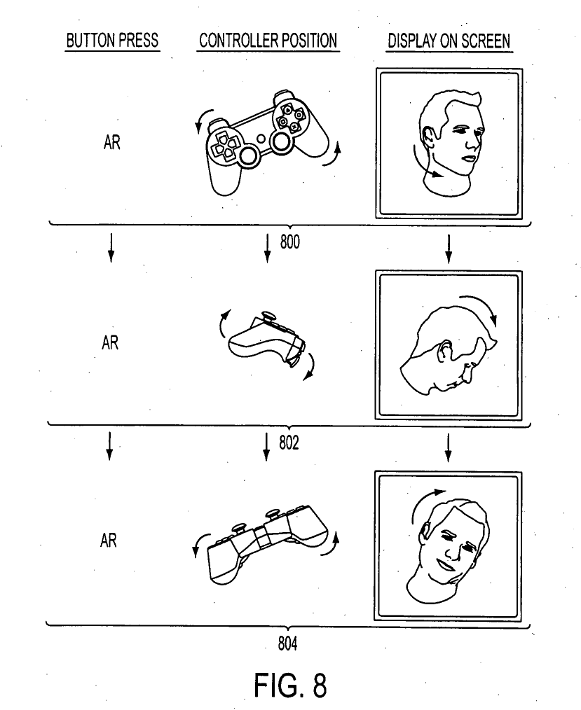

FIG. 8 illustrates controlling various motions of an avatar's head in accordance with one embodiment of the present invention. State 800 illustrates how depressing and holding the right analog stick button, AR, while yawing the controller 108, can turn an avatar's head. Thus, a user implementing the avatar control in state 800 would be able to turn their avatar's head in a side-to-side motion to non-verbally convey “no”. Conversely, in state 802, if a user pitches the controller 108 up and down while depressing and holding AR, the user can nod their avatar's head up and down to non-verbally convey “yes”. In state 804, rolling the controller 108 left and right while pressing and holding AR, can result in the user's avatar's head tilting to the left and right. It should be apparent to one skilled in the art an avatar's head could make compound motions based on a combination of user input controller selected from yaw, pitch and roll. Similarly, the compound motions based on yaw, pitch and roll can be mapped to other aspects of avatar animation.

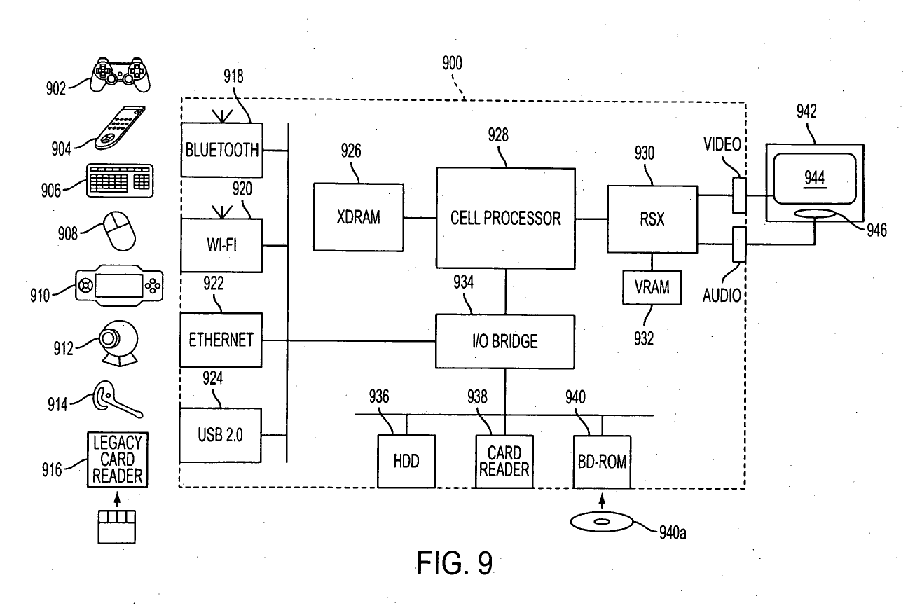

FIG. 9 schematically illustrates the overall system architecture of the Sony® Playstation 3® entertainment device, a console having controllers for implementing an avatar control system in accordance with one embodiment of the present invention. A system unit 900 is provided, with various peripheral devices connectable to the system unit 900. The system unit 900 comprises: a Cell processor 928; a Rambus® dynamic random access memory (XDRAM) unit 926; a Reality Synthesizer graphics unit 930 with a dedicated video random access memory (VRAM) unit 932; and an I/O bridge 934. The system unit 900 also comprises a Blu Ray® Disk BD-ROM® optical disk reader 940 for reading from a disk 940a and a removable slot-in hard disk drive (HDD) 936, accessible through the I/O bridge 934. Optionally the system unit 900 also comprises a memory card reader 938 for reading compact flash memory cards, Memory Stick® memory cards and the like, which is similarly accessible through the I/O bridge 934.

The I/O bridge 934 also connects to six Universal Serial Bus (USB) 2.0 ports 924; a gigabit Ethernet port 922; an IEEE 802.11b/g wireless network (Wi-Fi) port 920; and a Bluetooth® wireless link port 918 capable of supporting of up to seven Bluetooth connections.

In operation the I/O bridge 934 handles all wireless, USB and Ethernet data, including data from one or more game controllers 902. For example when a user is playing a game; the I/O bridge 934 receives data from the game controller 902 via a Bluetooth link and directs it to the Cell processor 928, which updates the current state of the game accordingly.

The wireless, USB and Ethernet ports also provide connectivity for other peripheral devices in addition to game controllers 902, such as: a remote control 904; a keyboard 906; a mouse 908; a portable entertainment device 910 such as a Sony Playstation Portable® entertainment device; a video camera such as an EyeToy® video camera 912; and a microphone headset 914. Such peripheral devices may therefore in principle be connected to the system unit 900 wirelessly; for example the portable entertainment device 910 may communicate via a Wi-Fi ad-hoc connection, whilst the microphone headset 914 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 916 may be connected to the system unit via a USB port 924, enabling the reading of memory cards 948 of the kind used by the Playstation® or Playstation 2® devices.

In the present embodiment, the game controller 902 is operable to communicate wirelessly with the system unit 900 via the Bluetooth link. However, the game controller 902 can instead be connected to a USB port, thereby also providing power by which to charge the battery of the game controller 902. In addition to one or more analog joysticks and conventional control buttons, the game controller is sensitive to motion in six degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation Portable device may be used as a controller. In the case of the Playstation Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 904 is also operable to communicate wirelessly with the system unit 900 via a Bluetooth link. The remote control 904 comprises controls suitable for the operation of the Blu-Ray Disk BD-ROM reader 940 and for the navigation of disk content.

The Blu Ray Disk BD-ROM reader 940 is operable to read CD-ROMs compatible with the Playstation and PlayStation 2 devices, in addition to conventional pre-recorded and recordable CDs, and so-called Super Audio CDs. The reader 940 is also operable to read DVD-ROMs compatible with the Playstation 2 and PlayStation 3 devices, in addition to conventional pre-recorded and recordable DVDs. The reader 940 is further operable to read BD-ROMs compatible with the Playstation 3 device, as well as conventional pre-recorded and recordable Blu-Ray Disks.

The system unit 900 is operable to supply audio and video, either generated or decoded by the Playstation 3 device via the Reality Synthesizer graphics unit 930, through audio and video connectors to a display and sound output device 942 such as a monitor or television set having a display 944 and one or more loudspeakers 946. The audio connectors 950 may include conventional analogue and digital outputs whilst the video connectors 952 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 928. The Playstation 3 device's operating system supports Dolby® 5.1 surround sound, Dolby® Theatre Surround (DTS), and the decoding of 7.1 surround sound from Blu-Ray® disks.

In the present embodiment, the video camera 912 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 900. The camera LED indicator is arranged to illuminate in response to appropriate control data from the system unit 900, for example to signify adverse lighting conditions. Embodiments of the video camera 912 may variously connect to the system unit 900 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 900, an appropriate piece of software such as a device driver should be provided. Device driver technology is well-known and will not be described in detail here, except to say that the skilled man will be aware that a device driver or similar software interface may be required in the present embodiment described.

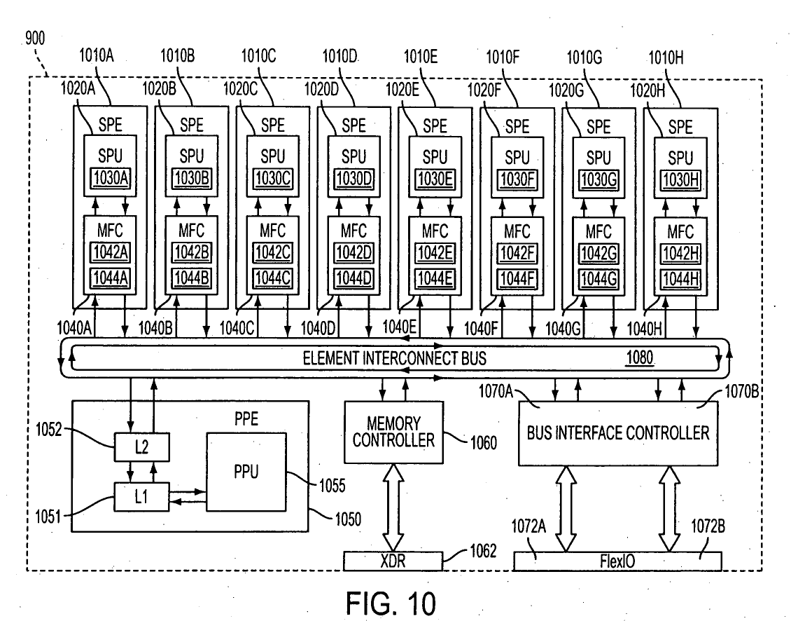

FIG. 10 is a schematic of the Cell processor 928 in accordance with one embodiment of the present invention. The Cell processors 928 has an architecture comprising four basic components: external input and output structures comprising a memory controller 1060 and a dual bus interface controller 1070A,B; a main processor referred to as the Power Processing Element 1050; eight co-processors referred to as Synergistic Processing Elements (SPEs) 1010A-H; and a circular data bus connecting the above components referred to as the Element Interconnect Bus 1080. The total floating point performance of the Cell processor is 218 GFLOPS, compared with the 6.2 GFLOPs of the Playstation 2 device's Emotion Engine.

The Power Processing Element (PPE) 1050 is based upon a two-way simultaneous multithreading Power 970 compliant PowerPC core (PPU) 1055 running with an internal clock of 3.2 GHz. It comprises a 512 kB level 2 (L2) cache and a 32 kB level 1 (L1) cache. The PPE 1050 is capable of eight single position operations per clock cycle, translating to 25.6 GFLOPs at 3.2 GHz. The primary role of the PPE 1050 is to act as a controller for the Synergistic Processing Elements 1010A-H, which handle most of the computational workload. In operation the PPE 1050 maintains a job queue, scheduling jobs for the Synergistic Processing Elements 1010A-H and monitoring their progress. Consequently each Synergistic Processing Element 1010A-H runs a kernel whose role is to fetch a job, execute it and synchronizes with the PPE 1050.

Each Synergistic Processing Element (SPE) 1010A-H comprises a respective Synergistic Processing Unit (SPU) 1020A-H, and a respective Memory Flow Controller (MFC) 1040A-H comprising in turn a respective Dynamic Memory Access Controller (DMAC) 1042A-H, a respective Memory Management Unit (MMU) 1044A-H and a bus interface (not shown). Each SPU 1020A-H is a RISC processor clocked at 3.2 GHz and comprising 256 kB local RAM 1030A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 1020A-H does not directly access the system memory XDRAM 926; the 64-bit addresses formed by the SPU 1020A-H are passed to the MFC 1040A-H which instructs its DMA controller 1042A-H to access memory via the Element Interconnect Bus 1080 and the memory controller 1060.

The Element Interconnect Bus (EIB) 1080 is a logically circular communication bus internal to the Cell processor 928 which connects the above processor elements, namely the PPE 1050, the memory controller 1060, the dual bus interface 1070A,B and the 8 SPEs 1010A-H, totaling 12 participants. Participants can simultaneously read and write to the bus at a rate of 8 bytes per clock cycle. As noted previously, each SPE 1010A-H comprises a DMAC 1042A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96B per clock, in the event of full utilization through arbitration between participants. This equates to a theoretical peak bandwidth of 307.2 GB/s (gigabytes per second) at a clock rate of 3.2 GHz.

The memory controller 1060 comprises an XDRAM interface 1062, developed by Rambus Incorporated. The memory controller interfaces with the Rambus XDRAM 926 with a theoretical peak bandwidth of 25.6 GB/s.

The dual bus interface 1070A,B comprises a Rambus FlexIO® system interface 1072A,B. The interface is organized into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 928 to the Reality Simulator graphics unit 930 will typically comprise display lists, being a sequence of commands to draw vertices, apply textures to polygons, specify lighting conditions, and so on.

Embodiments may include capturing depth data to better identify the real world user and to direct activity of an avatar or scene. The object can be something the person is holding or can also be the person's hand. In the this description, the terms “depth camera” and “three-dimensional camera” refer to any camera that is capable of obtaining distance or depth information as well as two-dimensional pixel information. For example, a depth camera can utilize controlled infrared lighting to obtain distance information. Another exemplary depth camera can be a stereo camera pair, which triangulates distance information using two standard cameras. Similarly, the term “depth sensing device” refers to any type of device that is capable of obtaining distance information as well as two-dimensional pixel information.

Recent advances in three-dimensional imagery have opened the door for increased possibilities in real-time interactive computer animation. In particular, new. “depth cameras” provide the ability to capture and map the third-dimension in addition to normal two-dimensional video imagery. With the new depth data, embodiments of the present invention allow the placement of computer-generated objects in various positions within a video scene in real-time, including behind other objects.

Moreover, embodiments of the present invention provide real-time interactive gaming experiences for users. For example, users can interact with various computer-generated objects in real-time. Furthermore, video scenes can be altered in real-time to enhance the user's game experience. For example, computer generated costumes can be inserted over the user's clothing, and computer generated light sources can be utilized to project virtual shadows within a video scene. Hence, using the embodiments of the present invention and a depth camera, users can experience an interactive game environment within their own living room. Similar to normal cameras, a depth camera captures two-dimensional data for a plurality of pixels that comprise the video image. These values are color values for the pixels, generally red, green, and blue (RGB) values for each pixel. In this manner, objects captured by the camera appear as two-dimension objects on a monitor.

Embodiments of the present invention also contemplate distributed image processing configurations. For example, the invention is not limited to the captured image and display image processing taking place in one or even two locations, such as in the CPU or in the CPU and one other element. For example, the input image processing can just as readily take place in an associated CPU, processor or device that can perform processing; essentially all of image processing can be distributed throughout the interconnected system. Thus, the present invention is not limited to any specific image processing hardware circuitry and/or software. The embodiments described herein are also not limited to any specific combination of general hardware circuitry and/or software, nor to any particular source for the instructions executed by processing components.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system, including an electromagnetic wave carrier. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for controlling an avatar in a virtual space, the virtual space accessed through a computer network using a console executing a computer program, comprising:
capturing activity of a console controller;
processing the captured activity of the console controller to identify input parameters; and
mapping selected ones of the input parameters to portions of the avatar, the avatar being a virtual space representation of a user;
wherein the capturing, processing and mapping are continuously performed to define a correlation between activity of the console controller and the avatar that is the virtual space representation of the user.

2. The method as described in claim 1, wherein activity of the console controller includes selecting of controller buttons.

3. The method as described in claim 1, wherein activity of the console controller includes sensing rotation and translation of the console controller in three-dimensional space.

4. The method as described in claim 3, wherein input parameters includes a rate of change in the rotation and translation velocity of the console controller.

5. The method as described in claim 1, wherein portions of the avatar include specific animated body parts.

6. The method as described in claim 4, wherein mapping selected ones of the input parameters to a portion of the avatar is done in proportion to acceleration and deceleration in the rotation and translation velocity of the console controller.

7. The method as described in claim 1, wherein the input parameters include selecting controller buttons, the controller buttons being mapped to initiate user control of different portions of the avatar animation when selected.

8. The method as described in claim 7, wherein the avatar animation is responsive and proportional to user controlled acceleration and deceleration of translational and rotational motion of the controller in three-axes.

9. A method for interactively controlling an avatar through a computer network using a console, comprising:
providing a console controller;
determining a first position of the console controller;
capturing input to the console controller, the input including detecting movement of the console controller to a second position;
processing input to the console controller and relative motion of the console controller between the first position and the second position; and
mapping the relative motion between the first position and the second position of the console controller to animated body portions of the avatar,
wherein the capturing, processing and mapping are continuously performed to define a correlation between relative motion of the console controller and the avatar.

10. The method as described in claim 9, wherein input to the console includes selecting console buttons.

11. The method as described in claim 10, wherein input to the console changes the mapping of relative motion of the console controller to different portions of the avatar.

12. The method as described in claim 9, wherein movement of the console controller can be detected in three-axes including translational and rotational movement in the three-axes.

13. The method as described in claim 9, wherein acceleration of the console controller is included as part of capturing input and detecting movement of the console controller.

14. The method as described in claim 9, wherein portions of the avatar include specific animated body parts.

15. The method as described in claim 9, wherein the avatar is a virtual representation of a user in a virtual environment, the virtual environment for the avatar accessed through the computer network and rendered by the console.

16. A computer implemented method for interactively controlling an avatar within a virtual environment, the avatar and virtual environment generated by a computer program that is executed on at least one computer in a computer network, comprising:
providing a controller interfaced with the computer program;
mapping controller input to allow a user to control a selected portion of the avatar;
capturing controller input and controller movement between a first position and a second position; and
processing the captured controller input and controller movement and applying the captured movement to interactively animate the selected portion of the avatar within the virtual environment,
wherein the capturing and processing of controller input and controller movement is continuously performed to define a correlation between controller movement and avatar animation.

17. The method as described in claim 16, wherein controller movement can be detected in three-axes including translational and rotational movement in all three-axes.

18. The method as described in claim 16, wherein capturing controller movement includes capturing acceleration and deceleration of the controller in rotational and translational movements of the controller in six-axes.

19. The method as described in claim 16, wherein the controller input includes selecting controller buttons, the controller buttons being mapped to initiate user control of different portions of the avatar animation when selected.

20. The method as described in claim 19, wherein animation of the selected portions of the avatar is responsive and proportional to user controlled acceleration and deceleration of translational and rotational motion of the controller in three-axes.
